(19) United States
(12) Patent Application Publication
(10) Pub. No.: US 2025/0110391 A1
(43) Pub. Date: Apr. 3, 2025

(54) CAMERA

(71) Applicant: Dream CHIP Technologies GmbH, Garbsen (DE)

(72) Inventor: Christian OVERMANN, Oldenburg (DE)

(73) Assignee: Dream CHIP Technologies GmbH, Garbsen (DE)

(21) Appl. No.: 18/725,430

(22) PCT Filed: Jul. 28, 2022
(86) PCT No.: PCT/EP2022/071166

§ 371 Date: Jun. 28, 2024

(51) Int. Cl. G03B 17/12; G02B 7/02; G03B 3/02; G03B 30/00; H04N 23/55; H04N 23/57

(52) U.S. Cl. CPC G03B 17/12; G02B 7/022; G03B 3/02; G03B 30/00; H04N 23/55; H04N 23/57

(57) ABSTRACT

The present invention discloses a camera comprising a camera housing having a threaded opening for receiving a lens, a lens with an optical axis having a threaded tube for screwing and the threaded opening of the camera housing, wherein the lens can be movably screwed into the threaded opening in the degree of freedom of the circumferential direction of the threaded tube and in the degree of freedom of the screwing direction of the lens aligned in the direction of the optical axis of the lens, and a locking element for fixing the lens screwed into the threaded opening in the camera housing. The locking element has a fixing contour which is designed to engage in one of the threads of the threaded opening or of the threaded tube, and is displaceable in a direction other than the degree of freedom in the circumferential direction and the degree of freedom in the insertion direction of the lens, wherein the locking element is arranged on the camera to engage the thread in the position displaced at an angle to the degrees of freedom.

### FIELD OF THE INVENTION

The invention relates to a camera having camera housing having a threaded opening for receiving a lens, a lens with an optical axis having a threaded tube for screwing and the threaded opening of the camera housing, wherein the lens can be movably screwed into the threaded opening in the degree of freedom of the circumferential direction of the threaded tube and in the degree of freedom of the screwing direction of the lens aligned in the direction of the optical axis of the lens, and a locking element for fixing the lens screwed into the threaded opening in the camera housing.

### BACKGROUND OF THE INVENTION

Cameras comprising an objective lens unit screwed into the threaded opening of the camera body are well-known in the prior art.

An accurately set flange focal distance, i.e. the distance between the imaging service of the imaging sensor and the lens mounting surface is of crucial importance to camera manufacturers and users. It has a strong impact on overall image quality and especially on image sharpness. To achieve the exact flange focal distance, either very tight manufacturing tolerances are required, which would significantly increase the price of the parts, or the incorporation of a mechanism for calibration is needed. However, this is costly so that an ordinary camera does not have any mechanisms to fix the back focus distance that deviates from the norm as a compromise, which severely limits the costumer's choices of lenses and filters since every element in the optical path between the sensor and the lens changes the back focus distance, which can result in a blurred image.

DE 1 978 475 U discloses a unit for axial adjustment of the lens of a camera in relation to the image plane. A clamping ring is provided, having two slits in radial direction and an eccentrically rotatable part comprising a threaded bore. A fixing screw is provided to be fastened in the threaded bore with the front plate of the camera housing.

DE 10 2015 114 198 B4 describes a camera housing comprising a housing body with an image sensor. The image sensor is arranged in the camera housing on an image sensor plane. The camera housing comprises a lens opening formed in the housing body and a receiving device for a lens. The lens is mountable in the imaging axis of the image sensor. A lens stop surface defines a position of the objective lens at a predetermined distance from the image sensor plane of the image sensor along the imaging axis. The camera housing comprises a receiving tube having a fastening device for a lens and a first contact surface. Further, a spacer ring with the defined signals is provided or a frictional acting press connection is formed between the receiving tubes and the mounting flange to fix the objective lens and the receiving tube in the predetermined distance to the image sensor plane.

DE 10 2015 114 203 B4 discloses a camera housing and a lens system for a camera comprising a lock for locking the lens in position relative to the image sensor plane. The lock includes a stop member connected to the lens or the lens mount and an elastic element arranged between the stop member and the lens mount or between the stop member and the lens. The elastic element is compressed between the stop member and the mount or between the stop member and the lens to lock the lens in position. The stop member acts as a counternut, which is screwed with an internal thread onto the external thread of the lens mount.

The known solutions of the prior art have the disadvantage that, for reasons of cost and space, they offer only inadequate protection against misalignment, do not allow the lens to be set in front of the image sensor, or are too complex for miniaturisation.

### SUMMARY OF THE INVENTION

Aspects of the present invention provide an improved camera designed for a simple, inexpensive and effectively secure flange focal lens adjustment for lens mounts on the camera side, which is precise and can be miniaturized, universally operated and universally integrated.

The camera comprises a locking element having a fixing contour which is designed to engage in one of the threads of the thread opening or of the threaded tube. The locking element is displaceable in a direction other than the degree of freedom in the circumferential direction and the degree of freedom in the insertion direction of the lens. The locking element is arranged on the camera to engage the thread in a position displaced at an angle to the decrease of freedom.

The fixing contour of the locking element engages in one of the threads of the threaded opening of the camera body or the thread of the threaded tube of the objective lens. The locking force by the engagement is caused by displacing the locking element in a specific direction. The specific direction of displacement is at an angle to the degrees of freedom of the objective lens screwed in the threaded opening of the camera body. Thus, the locking element is displaced in no case in direction of the freedom of the objective lens, i.e. in rotational direction around the circumferential of the threaded tube and in the insertion direction of the objective lens, e.g. the optical axis of the objective lens in the image sensor of the camera. Displacing the locking element in any direction other that the degrees of freedom of the objective lens has the effect that the objective lens is not moved with respect to the image plane of the image sensor in one of its directions of freedom when fastening the locking element. Further, also in the locked/fastened state of the locking element, the objective lens is fixed in its position since any force on the objective lens in its degrees of freedom does not loosen the locking force of the locking element.

For example, vibrational forces on the objective lens or camera housing are securely counteracted by the locking force of the locking element due to the displacement of the locking element and its fixing contour at an angle to the degrees of freedom of the objective lens.

In contrast, a counternut screwed on the threaded tube of the objective lens is movable in the degree of freedom of the objective lens and applies a pressing force in direction of the optical axis of the objective lens, i.e. one of the degrees of freedom of the objective lens. Such a counternut can loosen by itself due to vibrational forces. Rotation of the counternut can cause a rotation of the threaded tube of the objective lens and thus change the set focus.

Based on the simple operation and widespread use of threaded tubes of an objective lens for adjusting the flange focal distance, the locking element having a fixing contour designed to engage with one of the threads and to be displaceable at an angle of the degrees of freedom of the objective lens improves the precise centring of the objective lens while avoiding tilting and provides a reliable security regardless of the lens size used. The flange focal distance can be adjusted analogously to the prior art by screwing the unit in or out of a lens screwed in to the threaded tube. During the process, the threaded tube is circumferentially guided and precisely centred so that neither thread nor external forces on the lens or thread can cause tilting, blockage or misalignment.

Subsequently, to securely block any movement of the threaded tube, the locking element connects to the shape of the threaded tube or the thread of the threaded opening form a direction that does not coincide with any of the degrees of freedom of the threaded tube.

The locking element can be displaceable arranged adjacent to the threaded opening on the camera housing.

The locking element can be mounted on the camera housing transversely to the circumferential direction of the threaded opening radially in the direction of the optical axis and/or tangentially to the threaded opening.

The thread of the threaded opening of the camera housing can be interrupted by a recess. The locking element can be displaceable arranged in the recess. The fixing contour of the locking element can be curved corresponding to the contour of the thread of the threaded opening and continues said thread in the interrupted recess.

Thus, it is possible to interrupt and modify a portion of the connecting geometry of the contacting surfaces between the camera housing and the objective lens so that, while maintaining centring of the objective lens in the camera housing on the optical axis of the image sensor, the locking element can act relatively, e.g. perpendicularly, to the desired direction of movement of the threaded tube.

The locking element can be coupled with a clamping element which is movably mounted on or in the camera housing. This movable clamping element can be coupled with the locking element for linear displacement of the locking element. Thus, an additional clamping element, which is movable by an operator, is provided to displace the locking element by movement of the clamping element.

The clamping element can be coupled with the locking element via a spring element. Thus, the clamping element is not directly connected to the locking element, but indirectly via an intermediate spring element. The spring element can be arranged between the clamping and the locking element.

The spring element has the advantage to induce a specific force on the locking element defined by the spring characteristics. The displaced force applied to the locking element is therefore independent from tolerances of the clamping element, which may vary due to vibrational forces acting on the clamping element.

The clamping element can be designed to comprise a lever arm which is pivotally mounted on the camera housing. Said clamping element can comprise an eccentric-shaped actuating section being designed to exert a force causing the displacement of the locking element by the clamping element when the lever arm is pivoted.

The lever arm can be easily handled by the operator after setting the objective lens in precise position on the imaging plane of the imaging sensor. Fixing the objective lens by pivoting the lever arm is easy without touching or twisting the objective lens.

The locking element can comprise a threaded bore. The clamping element can be a clamping screw rotatable mounted in the threaded bore of the locking element. The clamping screw can be arranged to be supported on the camera housing for applying force to the locking element.

Rotating of the clamping screw can be easily done by a screwing tool. The clamping screw can be provided with a simple slot, a cross slot, a hexagon socket or a Torx contour or the like in the screw head. Such a form-fit contour in the screw head is accessible from the outside of the camera housing for a screwing tool.

The camera housing can comprise a threaded bore, wherein the clamping element is a clamping screw rotatable mounted in the threaded bore of the camera housing. The clamping screw can be arranged to apply force to the locking element when being screwed in the threaded bore and linearly displaced in the extension direction of the threaded bore and the clamping screw towards the locking element, or vice versa.

Said clamping screw can be rotatable mounted in said threaded bore so as to be displaceable in radial directions towards the optical axis. The threaded bore receiving said clamping screw has a direction of extension in radial direction towards the optical axis. Thus, in this embodiment the clamping screw provides a locking force in radial direction towards the optical axis, i.e. radial on the threaded bore of the threaded tube of the objective lens. This direction is perpendicular to the degrees of freedom of the threaded tube of the objective lens.

Said clamping screw can be rotatable mounted in the threaded bore so as to be displaceable in a direction tangential to the threaded opening. Said threaded bore receiving said clamping screw has a direction of extension in a direction tangential to the threaded opening. In this embodiment, the clamping screw applies a clamping force to the locking element and displacement in a direction tangential to the circumferential (the circle) of the threaded bore. Also in this embodiment, the displacement and clamping force are applied perpendicularly to the directions of freedom of the objective lens.

### BRIEF DESCRIPTION OF THE DRAWINGS

The present invention is described by way of exemplary embodiments with reference to the enclosed drawings, in which:

FIG. 1—schematic side cut view of a camera comprising a camera housing and a lens;

FIG. 2—perspective view of the first embodiment of the camera housing;

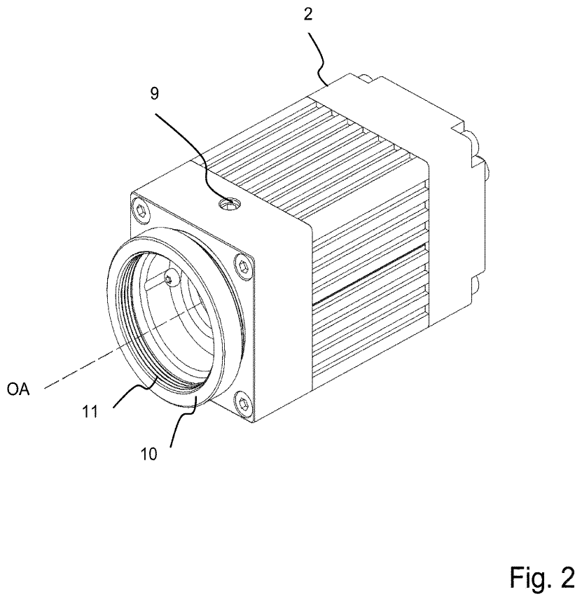

FIG. 3—perspective section view with a cut-out of the first embodiment of the locking element;

FIG. 4—perspective section view with a cut-out of the second embodiment of the locking element;

FIG. 5—backside view in the camera housing with the displaceable locking element;

FIG. 6—perspective view of the threaded opening with the locking element having a thread contour;

FIG. 7—perspective section view with a cut-out of the fourth embodiment of the locking element;

FIG. 8—backside view of the threaded opening of the camera housing of the embodiment of FIG. 7;

FIG. 9—perspective section view with a cut-out of the fifth embodiment of the locking element comprising a lever arm;

FIG. 10—front cut view of the camera housing of FIG. 9;

FIG. 11—perspective sectional view of the camera housing with a cut-out of the sixth embodiment of the locking element and the lever arm.

### DETAILED DESCRIPTION OF THE INVENTION

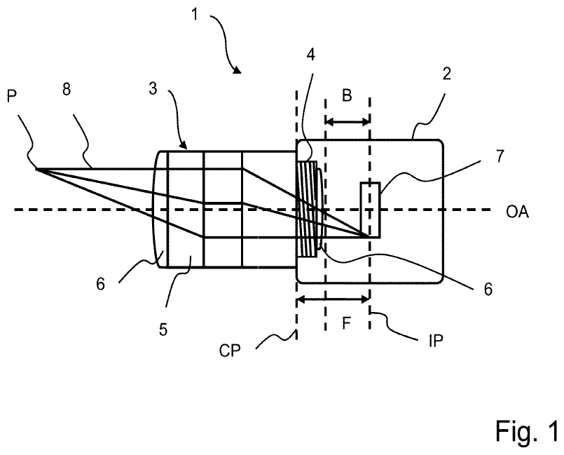

FIG. 1 shows a side sectional view of the camera 1 comprising a camera housing 2 and a lens 3, i.e. an objective lens or lens unit. The lens 3 comprises a threaded tube 4 on a tubular housing 5. The tubular housing 5 incorporates at least one lens element 6 to form an objective lens. The threaded tube 4 is screwed in a threaded opening of the camera housing 2 at a desired back focal distance B to the image plane IP of an image sensor 7 accommodated in the camera housing 2. The image sensor 7 with its image plane IP is placed at a specific distance to the camera front plane CP. The distance between the camera front CP and the image plane IP is fixed by the design of the camera housing 2 accommodating the image sensor 7 and called flange back F.

The optical light path 8 from a point of light P passes the lens element 6 of the objective lens 3 and reaches light sensitive elements of the image sensor 7. In order to provide a sharp focus of the point P of a source of light on a specific sensitive point of the image sensor 7 on the image plane IP, the back focal distance of the objective lens 3 requires precise adjustment. The adjustment can be reached by screwing the lens 3 in the threaded opening of the camera housing 2 with its threaded tube 4 along the optical axis OA until a sharp image captured by the image sensor 7 is achieved. The back focal distance B must be fixed when using the camera 1.

In order to lock the lens 3 in the set focal position with respect to the image plane IP, a locking element displaceable by a clamping screw 9 is provided in the camera housing 2. The camera housing 2 comprises a threaded opening 14 in the front of the camera housing 2. The threaded opening 10 comprises a thread F with a thread flanks (ridges) helically winding around the optical axis OA.

The clamping screw 9 is rotatable mounted in a threaded bore and can be displaced radially in the direction to the optical axis OA. Thus, rotating the clamping screw 9 causes a displacement of the locking element coupled with the clamping screw 9 in a radial direction towards the optical axis OA, and vice versa.

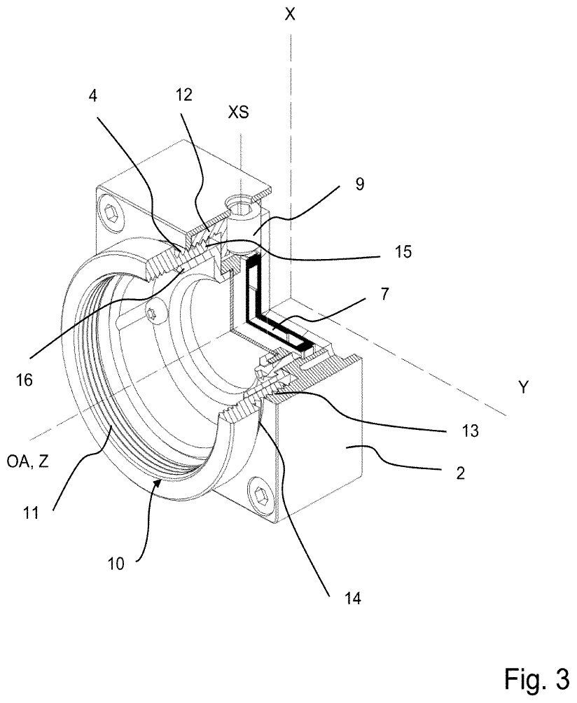

FIG. 3 shows a side sectional view with a cut-out area of the locking element 12.

The threaded tube 10 of the objective lens is screwed with its outer thread 4 into a corresponding inner thread 13 at the threaded opening 14 of the camera housing 2. Due to the cylindrical design of the threaded opening 14 at its inner thread 13 of the camera housing 2, the threaded tube 10 of the objective lens 3 and an objective lens housing 5 screwed on the inner thread 11 of the threaded tube 10 provide a precise position centred on the optical axis OA.

The inner thread 13 of the threaded opening 14 is interrupted by a recess, e.g. the top section of the camera housing 2 is shown. The locking element 12 is displaceable arranged in the recess. The locking element 12 comprises a fixing contour 15 being curved and corresponding to the contour of the inner thread 13 of the threaded opening 14. The thread fixing contour 15 continues the inner thread 13 in the interrupted recess of the threaded opening 14. Thus, the outer thread 4 of the threaded tube 10 is also threaded with the fixing contour 15 of the locking element 12.

To secure the set distance of the objective lens 3 with respect to the image plane IP of the images sensor 7, the clamping screw 9 interacts with the locking element 12 in order to tighten the engagement of the fixing contour 15 by the thread 4 of the threaded tube 10. The locking element 12 is designed in such a way that, on one hand, it is guided precisely and twist-proof in the threaded opening 14 along the axis XS, i.e. radially towards the optical axis OA, and, on the other hand, it has a mating surface that engages conformably with the external thread 4 of the threaded tube 10. The mating surface of the fixing contour 15 is displaced perpendicular to the thread 4 of the threaded tube 10 by tightening of the clamping screw 9 on the axis XS, thereby interrupting the surrounding thread geometry of the threaded opening 4. This reliably prevents independent and/or unintentional adjustment of the threaded tube 10, i.e. the objective lens 3. The securing effect is created by both a form fit and a force fit.

Optionally, an additional internal centring of the objective lens 3 on the camera housing 2 with respect to the optical axis OA is provided by a contact surface 16 on a support element. Said contact surface 16 can be integrally formed within the camera housing 2. The support element can be tubular to provide a contact surface 16 at its outer circumferential for the inner tubular surface of the threaded tube 10. This ensures that the lens 3 is concentric with the centre of the imaging surface of the image sensor 7 on the optical axis OA.

The cylindrical design of the internal centring by the support element and its contact surface 16 allows both precise centring of the threaded tube 10, which servers analogously for mounting of the lens 3, and simple, miniaturisable and efficient mechanical manufacturing.

To set the flange focal distance, the lens 3 is now screwed into the threaded tube 10 and then rotated clockwise or counter-clockwise as a unit while the camera 2 is running until the desired sharpness is achieved. Then the clamping screw 9 is fastened to tighten the locking element 12 on the thread 4 of the threaded tube 10 to fix the objective lens 3 in tis focal position relative to the image sensor 7.

Depending on the geometry of the camera housing 2, the clamping screw 9 remains accessible from the outside for the operator at all times, regardless of the diameter of the lens 3 used.

The screw head of the clamping screw 9 comprises a formfitting contour for interaction with a screw driver, i.e. an internal hexagon as shown, a slit, a cross slit, a Torx contour or the like.

The clamping screw 9 is screwed into a threaded bore of the locking element 12. The screw head is placed in a formfitting position below the top cover of the camera housing 2. Thus, the clamping screw 9 is supported on the camera housing when displacing the locking element 12 by rotation of the clamping screw 9 in the threaded bore of the locking element 12.

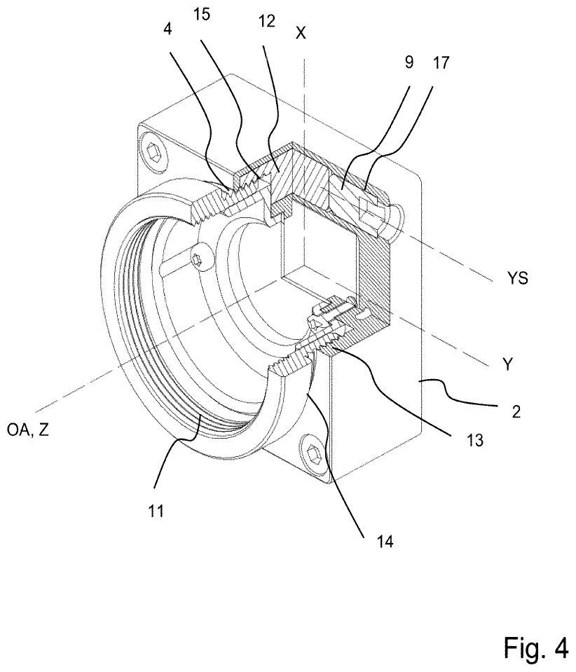

FIG. 4 presents a perspective sectional view in a quarter cut in the area of the locking element 12. The locking element 12 is displaceable arranged in the camera housing 2 in horizontal direction Y. The clamping screw 9 is rotatable mounted in a threaded bore 17 in the camera housing 2. When rotating the clamping screw 9 around the vertical axis Y, the clamping screw 9 is linearly displaced in the horizontal direction Y to apply a pressure force onto the locking element 12. Due to the horizontal displacement of the clamping screw 9, the locking element 12 is displaced in the horizontal direction Y, i.e. in the direction tangential to said threaded opening 14 and the threaded tube 10 of the objective lens 3. Thus, the mechanical direction of action of the clamping screw 9 is tangential, e.g. along the axis YS, instead of the normal direction shown in FIG. 3.

In this case, the precise and torsion-proof locking element 12 guided in the flange along the axis YS is not clamped perpendicularly after setting the sharpness of the camera, but tangentially to the thread surface of the threaded tube 10 via the clamping screw 9. The clamping screw forms a clamping element interacting with the locking element 12.

By breaking the surrounding geometry of the flange and inducing a force on the thread flanks of the threaded tube 10 via the conforming geometry of the fixing contour 15 of the locking element 12, the resulting effect is comparable to that explained in FIG. 3.

In addition, there is a form fit and force fit. An unintentional adjustment is reliably prevented while at the same time integrability in the miniaturized cameras is maintained.

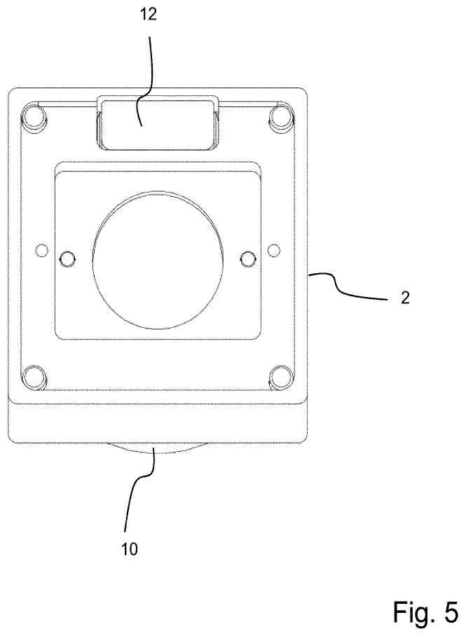

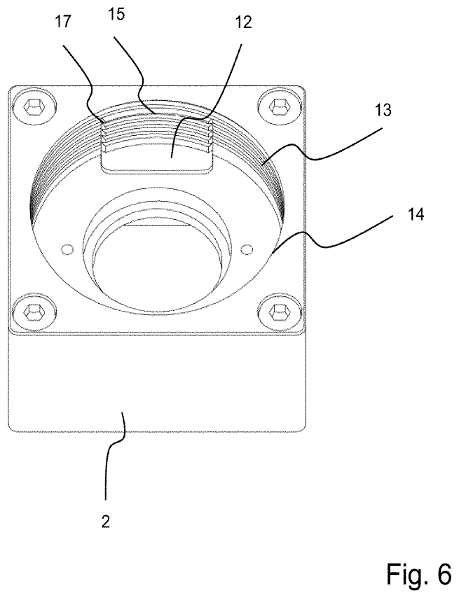

FIG. 5 shows the rear view and FIG. 6 an inclined perspective front view of two different locking versions of the camera housing 2. It can be seen that the locking element 12 is inserted into a recess in the area of the inner thread 13 of the threaded opening. There is a gap between the locking element 12 and the camera housing 2, which allows a displacement of the locking element in the horizontal direction YS shown in FIG. 5 and in the vertical direction XS shown in FIG. 6.

In the embodiment of FIG. 3, the gap would be in a radial direction in the upper or lower part of the locking element 12 to allow radial displacement of the locking element 12.

FIG. 6 presents the fixing contour 15 of the locking element 12, which corresponds to the adjacent helically wound thread flanks of the inner thread 13 of the threaded opening 14. The thread flanks of the fixing contour 15 of the locking element 12 are offset inwards, relative to the thread 13 of the threaded opening 14. This is achieved by displacing the locking element 12 in the recess formed by the interruption of the threaded opening 14.

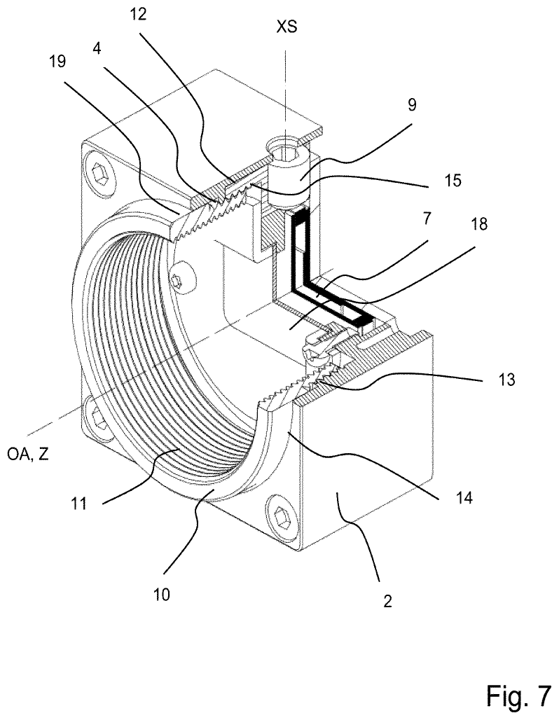

FIG. 7 is a perspective sectional view with a quarter cut in the area of the locking element 12 of the camera housing 2. The design is similar to the embodiment shown in FIG. 3.

In contrast to this design, the additional internal support element comprising the contact surface 16 is missing. The orientation of the threaded tube 10 at the objective lens 3 along the optical axis OA is safeguarded by the aligning surface pairing 19 of the threaded opening 14 in the camera housing 2 and the corresponding outer thread 4 of the threaded tube 10.

The focus of this embodiment is on alternative centring. Sometimes, it may be necessary to keep the area of the optical axis OA, especially the area between the image sensor 7, a filter element 18 and a lens flange, as free of components as possible. In order to carry out the previously described adjustability and reliable locking, the objective lens 3 even with precise lens centring, the threaded tube 10 can also be centred at its outer diameter. For this purpose, it is sufficient to extent the flange, e.g. the length of the threaded opening 14, to the front side to such an extent and to enclose it by the mating surface 19 at least surrounding the threaded tube 10 in such a way that it is precisely guided and centred. Thus, the flange section front of the outer thread 13 of the camera housing 2 in the front side of the threaded opening 14 and the flat outer surface of the tubular objective lens 3 at its threaded tube 10 (mating surface 19) have the same function as the inner support element comprising the contact surface 16 at the inner diameter in FIG. 3.

This type of centring prevents tilting due to the mechanical force exerted in vertical direction as well as tangential direction by the locking element 12.

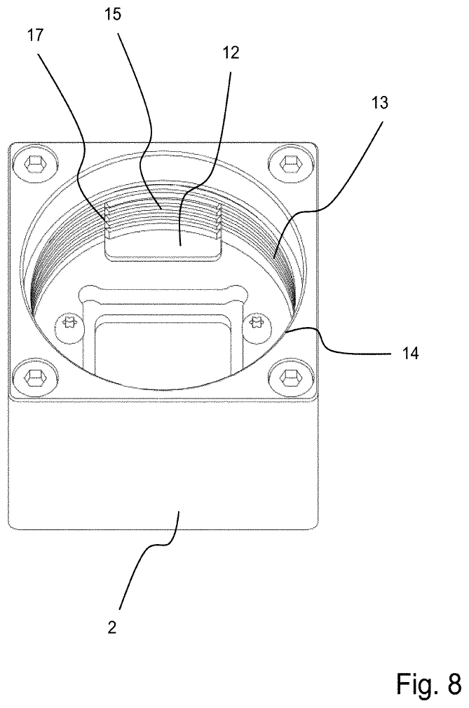

FIG. 8 presents an inclined perspective front view of the camera housing 2 with the locking element 12 displaceable mounted within the recess 17 of the threaded opening 14. It is similar to the embodiment shown in FIG. 6 except for the squared opening for the filter element 18 towards the image sensor 7.

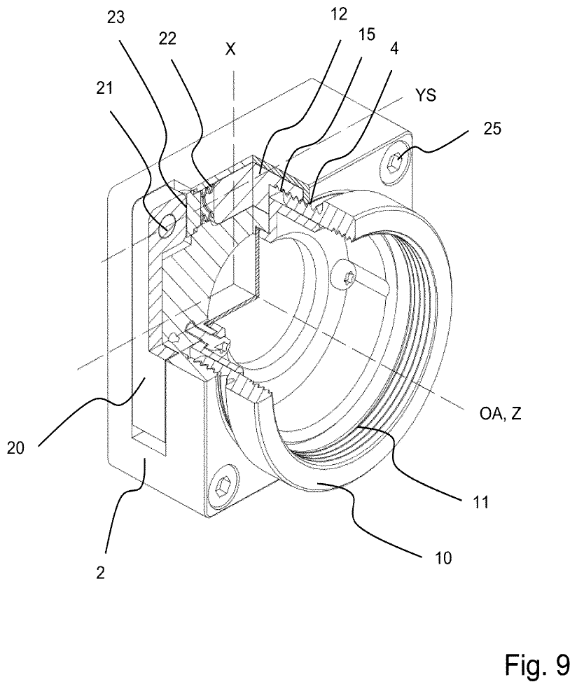

FIG. 9 presents a perspective sectional view of another embodiment of the camera 1 with a quarter cut in the location of the locking element 12. The operation of this embodiment is analogous to the embodiment in FIG. 4. However, no tool is required. The clamping element interacting with the locking element 12 is provided by a lever arm 20 instead of a clamping screw 9. A pivoting lever arm 20 in the shown locking position around the pivoting axis 21 causes a force applied to the locking element 12 in horizontal displacement direction YS.

In this embodiment, an optional spring element 22 is provided between the lever arm 20 and the locking element 12.

Before the back focus can be set or adjusted, the lever arm 20 must firstly be folded upwards, e.g. by 90°. This releases the locking element 12, which engages with a thread of the internally centred threaded tube 10 via the conformal geometry of the fixing contour 15. After displacing the locking element 12 in the open position in which the thread of the fixing contour 15 is aligned with the outer thread 4 of the threaded tube 10, the threaded tube 10 can be rotated either alone or as a unit with the objective lens 3 screwed into the internal thread 11, and thus the flange focal distance can be adjusted.

As soon as the desired focus is achieved, the lever arm 20 is folded back again, whereby the locking element 12, which is guided precisely and twist-proof in the flange along the axis YS, is clamped tangentially to the threaded surface of the threaded tube 10.

The lever arm 20 comprises, adjacent to the pivot axis 21, an eccentric-shaped actuation section 23 to vary the distance of the eccentric-shaped actuation section 23 and the horizontally displaceable locking element 12 when swivelling the lever arm 20.

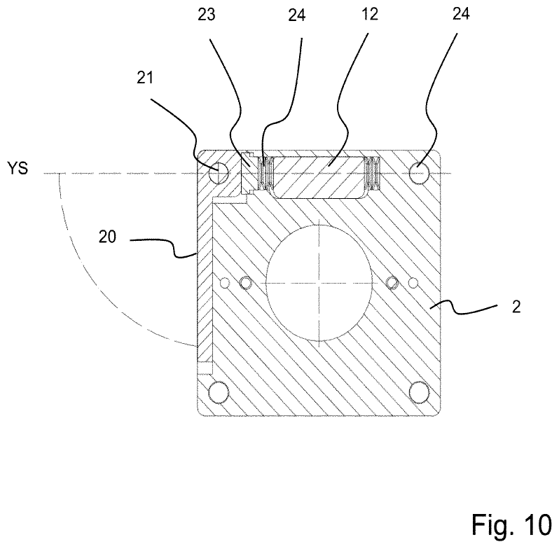

Optionally, the force applied to the locking element 12 from the lever arm 20 can be induced adjustably via springs 21 as shown in FIG. 10.

The force can also be applied directly by the lever arm 20 without such additional spring elements 24. In the embodiment shown in FIG. 10, the springs 24 are provided at both sides of the locking element 12 in its direction of displacement YS. Thus, one spring element 24 is positioned between the eccentric-shaped actuation section 23 of the lever arm 20 and the locking element 12. The second, optional spring element 24 is provided on the opposite side at a distance from the lever arm 20 between the locking element 12 and the camera housing 2.

In order to maintain a small overall size, it is preferred to form the lever's arm 20 axis 21 of rotation by a screw connecting the front to the rest of the camera 1. Thus, the pivot axis 21 is formed by the fastening element having a second function of the fastening screws 25 provided as four corners of the camera housing 2.

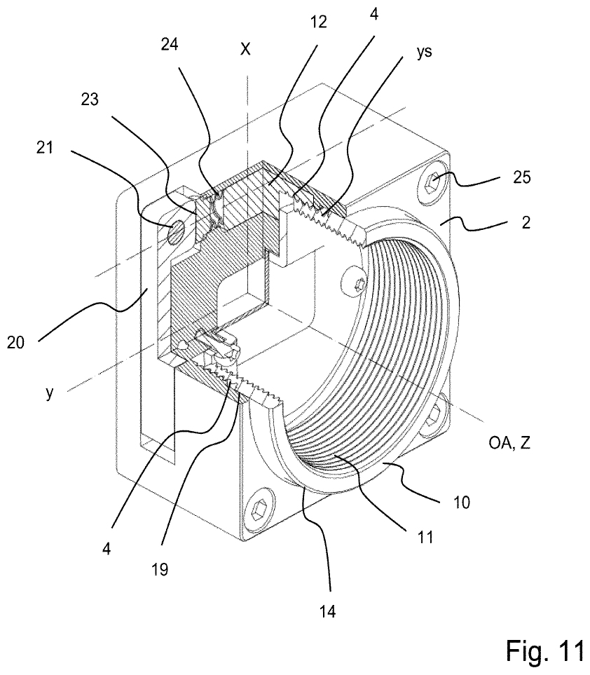

FIG. 11 presents a perspective sectional view of the camera housing 2 similar to the embodiment of FIG. 9, but with the outer centring of the threaded tube 10 as shown in FIG. 7 instead of the inner centring by the internal support element comprising the contact surface 16 as shown in FIG. 3.

The mechanical locking mechanisms make it possible both to set the flange focal lens precisely and easily and to lock it securely with little effort. The mechanical design reliably prevents unintentional loosening and adjustment of the set back focus.

In addition to the improved locking, tilting caused, for example, by activation of the lock is prevented while precisely aligning the threaded tube 10 and thus the lens on the optical OA of the image sensor 7.

The various embodiments show that the technical solution is both easily implementable and versatile adaptable, and thus can be quickly and easily integrated into a wide variety of camera geometries.

Furthermore, the alternative embodiments illustrate that the technical solutions are adaptable in such a flexible manner that they can be operated in a user-friendly manner both with and without tools, thus enabling the focus adjustment to always be easily accessible and convenient when using lenses of any diameter without any problems.

Finally, all elements can be easily and cost-effectively integrated or retrofitted into miniaturized cameras.

1. A camera comprising
a camera housing having a threaded opening for receiving a lens,
a lens with an optical axis having a threaded tube for threaded engagement with the threaded opening of the camera housing, wherein the lens can be movably screwed into the threaded opening in the degree of freedom of the circumferential direction of the threaded tube and in the degree of freedom of the screwing direction of the lens aligned in the direction of the optical axis of the lens, and
a locking element for fixing the lens screwed into the threaded opening in the camera housing,
wherein
the locking element has a fixing contour which is designed to engage in one of the threads of the threaded opening or of the threaded tube, and
in that the locking element is displaceable in a direction other than the degree of freedom in the circumferential direction and the degree of freedom in the insertion direction of the lens, wherein the locking element is arranged on the camera to engage the thread in the position displaced at an angle to the degrees of freedom.

2. The camera according to claim 1, wherein the locking element is displaceably arranged adjacent to the threaded opening in the camera housing.

3. The camera according to claim 2, wherein the locking element is mounted on the camera housing transversely to the circumferential direction of the threaded opening (14) radially in the direction of the optical axis and/or tangentially to the threaded opening.

4. The camera according to claim 1, wherein the thread of the threaded opening of the camera housing is interrupted by a recess, the locking element being displaceably arranged in the recess, wherein the fixing contour of the locking element being curved corresponds to the contour of the thread of the threaded opening and continues said thread in the interrupted recess.

5. The camera according to claim 1, wherein the locking element is coupled with a clamping element movably mounted on or in the camera housing and coupled with the locking element for linear displacement of the locking element.

6. The camera according to claim 5, wherein the clamping element is coupled with the locking element via a spring element, the spring element being arranged between the clamping element and the locking element.

7. The camera according to claim 5, wherein the clamping element comprises a lever arm pivotably mounted on the camera housing, said clamping element comprising an eccentric-shaped actuating section, the actuating section being designed to exert a force causing the displacement of the locking element by the clamping element when the lever arm is pivoted.

8. The camera according to claim 5, wherein the locking element comprises a threaded bore, and that the clamping element is a clamping screw rotatably mounted in the threaded bore of the locking element, wherein the clamping screw is arranged to be supported on the camera housing for applying force to the locking element.

9. The camera according to claim 5, wherein the camera housing comprises a threaded bore, and that the clamping element is a clamping screw rotatably mounted in the threaded bore of the camera housing, wherein the clamping screw is arranged to apply force to the locking element.

10. The camera according to claim 8, wherein said clamping screw is rotatably mounted in said threaded bore so as to be displaceable in radial direction towards the optical axis, wherein said threaded bore receiving said clamping screw has a direction of extension in radial direction towards the optical axis.

11. The camera according to claim 8, wherein said clamping screw is rotatably mounted in said threaded bore so as to be displaceable in a direction tangential to said threaded opening, wherein said threaded bore receiving said clamping screw has a direction of extension in a direction tangential to said threaded opening.
